(19) United States
(12) Patent Application Publication
(10) Pub. No.: US 2014/0156799 A1
(43) Pub. Date: Jun. 5, 2014

(54) Method and System for Extracting Post Contents From Forum Web Page

(71) Applicants: PEKING UNIVERSITY FOUNDER GROUP CO., LTD., Beijing (CN); BEIJING FOUNDER ELECTRONICS CO., LTD., Beijing (CN); PEKING UNIVERSITY, Beijing (CN)

(72) Inventors: Tao Zhang, Beijing (CN); Jianwu Yang, Beijing (CN); Xiaoming Yu, Beijing (CN)

(73) Assignees: PEKING UNIVERSITY FOUNDER GROUP CO., LTD., Beijing (CN); BEIJING FOUNDER ELECTRONICS CO., LTD., Beijing (CN); PEKING UNIVERSITY, Beijing (CN)

(21) Appl. No.: 14/093,157

(22) Filed: Nov. 29, 2013

(30) Foreign Application Priority Data
Dec. 3, 2012 (CN) 201210511269.7

(51) Int. Cl. H04L 12/24

(52) U.S. Cl. CPC H04L 41/5083
USPC 709/218

(57) ABSTRACT

The present application discloses a method and a system for extracting post contents from a forum web page. The method includes: acquiring a forum web page; converting the forum web page into a DOM tree, wherein the DOM tree at least includes a root node and at least one child node attached to the root node; generating frequent patterns for the root node and the at least one child node in a one-to-one correspondence mode; determining a node corresponding to information contents in the forum web page according to a frequent pattern, satisfying a preset condition, in the frequent patterns; and extracting the information contents in the forum web page from the node corresponding to the information contents in the forum web page based on a preset common sub-tree algorithm.

### FIELD OF THE INVENTION

The present application relates to the field of computer Internet, and particularly, relates to a method and a system for extracting post contents from a forum web page.

### BACKGROUND OF THE INVENTION

With increasing popularization and rapid development of Internet, forums have become important data resources in networks. As the forums provide a large amount of very valuable knowledge and information about various subjects for people, information would be extracted from forum data and various applications would established for more and more research work.

In order to effectively utilize the forum data, structured data are extracted from forum web pages first in most applications, and these data are further utilized to realize various functions.

At present, methods for extracting forum information are mostly based on rules, and are generally directed to the rules designated by a certain website, thus constructing a wrapper. The wrapper is a software component, and is mainly constructed through the following two approaches:

I, a knowledge engineering approach, namely, formulating an extraction rule through a domain expert;

II, a machine learning approach, which is adopted for automatically constructing the wrapper, and establishing an extraction model according to a labeled template and a machine learning algorithm through automatic learning.

In the process of implementing embodiments of the present application, the applicant discovers that the above-mentioned technical means at least have the following problems:

I, when the extraction rule is formulated through the domain expert, a large quantity of manpower is needed, and the cost is very high;

II, when the machine learning approach is adopted, a sample needs to be manually labeled.

The above-mentioned information extraction technology using the wrapper depends on human aid to a certain extent and is relatively low in automation degree. Meanwhile, because a forum web page is diverse in form and is continually updated, the wrapper is not suitable for large-scale application due to relatively high maintenance cost and poor applicability.

### SUMMARY OF THE INVENTION

The present application provides a method for extracting post contents from a forum web page, to solve the problems of low automation and poor applicability of information extraction in the prior art.

In one aspect, the following technical solution is provided through an embodiment of the present application:

a method for extracting post contents from a forum web page, including:

acquiring a forum web page;

converting the forum web page into a DOM tree, wherein the DOM tree at least includes a root node and at least one child node attached to the root node;

generating frequent patterns for the root node and the at least one child node in a one-to-one correspondence mode;

determining a node corresponding to information contents in the forum web page according to a frequent pattern, satisfying a preset condition, in the frequent patterns; and

extracting the information contents in the forum web page from the node corresponding to the information contents in the forum web page based on a preset common sub-tree algorithm.

Alternatively, the frequent pattern satisfying the preset condition is specifically a maximal frequent pattern; and the preset common sub-tree algorithm is specifically a maximal common sub-tree algorithm.

Alternatively, the converting the forum web page into the DOM tree specifically includes:

deleting useless web page labels from the forum web page; and

converting the forum web page from which the useless web page labels are deleted into the DOM tree.

Alternatively, the extracting the information contents in the forum web page from the node corresponding to the information contents in the forum web page based on the preset common sub-tree algorithm specifically includes:

filtering out same parts among posts in the forum web page; and

extracting the information contents in the forum web page from the node corresponding to the information contents in the forum web page based on the maximal common sub-tree algorithm.

Alternatively, before the node corresponding to the information contents in the forum web page is determined according to the frequent pattern satisfying the preset condition in the frequent patterns, the method also includes:

judging whether the frequency and support of each frequent pattern in the frequent patterns are greater than or equal to a preset frequency and support or not; and

when the frequency and support of a frequent pattern are smaller than the preset frequency and support, pruning the frequent pattern.

Alternatively, the preset frequency and support are specifically a minimum frequency and a minimum support.

In another aspect, the following technical solution is provided through another embodiment of the present application:

a system for extracting post contents from a forum web page, including:

an acquiring module, configured to acquire a forum web page;

a converting module, configured to convert the forum web page into a DOM tree, wherein the DOM tree at least includes a root node and at least one child node attached to the root node;

a generating module, configured to generate frequent patterns for the root node and the at least one child node in a one-to-one correspondence mode;

a determining module, configured to determine a node corresponding to information contents in the forum web page according to a frequent pattern, satisfying a preset condition, in the frequent patterns; and

an extracting module, configured to extract the information contents in the forum web page from the node corresponding to the information contents in the forum web page based on a preset common sub-tree algorithm.

Alternatively, the frequent pattern satisfying the preset condition is specifically a maximal frequent pattern; and the preset common sub-tree algorithm is specifically a maximal common sub-tree algorithm.

Alternatively, the converting module specifically includes:

a deleting unit, configured to delete useless web page labels from the forum web page; and

a converting unit, configured to convert the forum web page from which the useless web page labels are deleted into the DOM tree.

Alternatively, the extracting module specifically includes:

a filtering unit, configured to filter out same parts among posts in the forum web page; and

an extracting unit, configured to extract the information contents in the forum web page from the node corresponding to the information contents in the forum web page based on the maximal common sub-tree algorithm.

Alternatively, the system also includes:

a judging module, configured to judge whether the frequency and support of each frequent pattern in the frequent patterns are greater than or equal to a preset frequency and support or not; and

a pruning module, configured to, when the frequency and support of a frequent pattern are smaller than the preset frequency and support, prune the frequent pattern.

One or more of the above-mentioned technical solutions have the following technical effects or advantages:

I. By adopting the method for extracting the post contents from the forum web page provided in the present application, the defects of low automation degree and poor system applicability during extraction of the post contents in the prior art is overcome, and thus the method has a wider application range.

II. By extracting the maximal frequent pattern of posts, positioning the node of the post contents in the frequent pattern tree and adopting the maximal common sub-tree dynamic planning matching algorithm, related metadata of all master and slave post contents, posting time, writer, floor information and the like in the post contents can be extracted quickly, accurately and completely.

### BRIEF DESCRIPTION OF THE DRAWINGS

FIG. 1 is a flow diagram of a method for extracting post contents from a forum web page in an embodiment of the present application;

FIG. 2 is a schematic diagram of a frequent pattern tree in an embodiment of the present application;

FIG. 3 is a structural diagram of web page post contents in an embodiment of the present application; and

FIG. 4 is a structural diagram of a system for extracting post contents from a web page forum in an embodiment of the present application.

### DETAILED DESCRIPTION OF THE EMBODIMENTS

In the present application, a maximal frequent pattern of post pages is extracted according to web page contents corresponding to the acquired forum post pages, a node of post information contents is calculated through the maximal frequent pattern, same parts among posts are filtered out on the basis of a maximal common sub-tree algorithm, and post contents and metadata are further extracted. Meanwhile, contents and metadata of other posts in the same forum may also be extracted according to a method provided in the present application.

Main implementation principles and specific implementations of technical solutions of the embodiments of the present invention and beneficial effects correspondingly achieved by the technical solutions are illustrated in detail below in conjunction with the accompanying drawings.

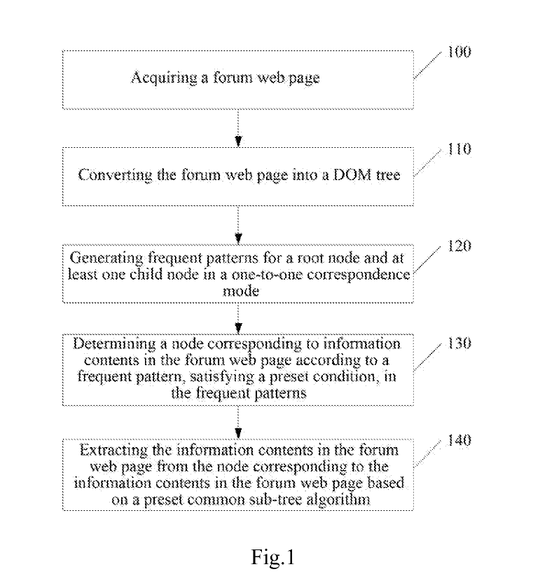

Please refer to FIG. 1, which is a flow diagram of a method for extracting post contents from a forum web page in an embodiment of the present application;

step 100, acquiring a forum web page;

in the specific implementation process, when the post contents in the web page are extracted, an acquisition page task is created first and saved in the form of a list page, and a corresponding web page address is automatically acquired from a URL in the list page based on intervals of this acquisition task. For example, if the post contents in a Fish Leong Baidu Post Bar are desired to be acquired, the address of the acquisition task of the post contents is http://tieba.baidu.com/f?kw=%C1%BA%BE%B2%C8%E3#.

Step 110, converting the forum web page into a DOM (Document Object Model) tree;

in the specific implementation process, when forum web page contents corresponding to the web page address are acquired on the basis of the web page address in the aforementioned step 110, useless web page labels in the forum web page are deleted first; and specifically, the useless web page labels includes head nodes, comment nodes, script nodes, input nodes, form nodes, select nodes, textarea nodes, style nodes, font nodes and the like. Those skilled in the art should understand that, according to actual application conditions, other same or similar web page labels are covered within the protection scope of the present application, and are not described redundantly herein.

Then the forum web page from which the useless web page labels are deleted is converted into the DOM tree, which at least includes a root node and at least one child node attached to the root node;

step 120, generating frequent patterns for the root node and the at least one child node in a one-to-one correspondence mode;

firstly, WEB data and definition of the frequent patterns are given by a frequent pattern tree. For a certain set A, suppose that |A| represents the cardinality (size) of A, L={L0, L1, L2 . . . L n} expresses a finite alphabet corresponding to attributes in semi-structured data or used for marking a text.

The frequent pattern tree established on L, called a frequent tree for short, is a sextet OT={V, E, B, L, M, r }, wherein V is a finite node set, E=V×V represents parent and child, and E satisfies a parent-child relation. B represents a satisfied (probably indirect) brother relation. Any node in the frequent tree may reach another node through a path, and this path is called a frequent pattern.

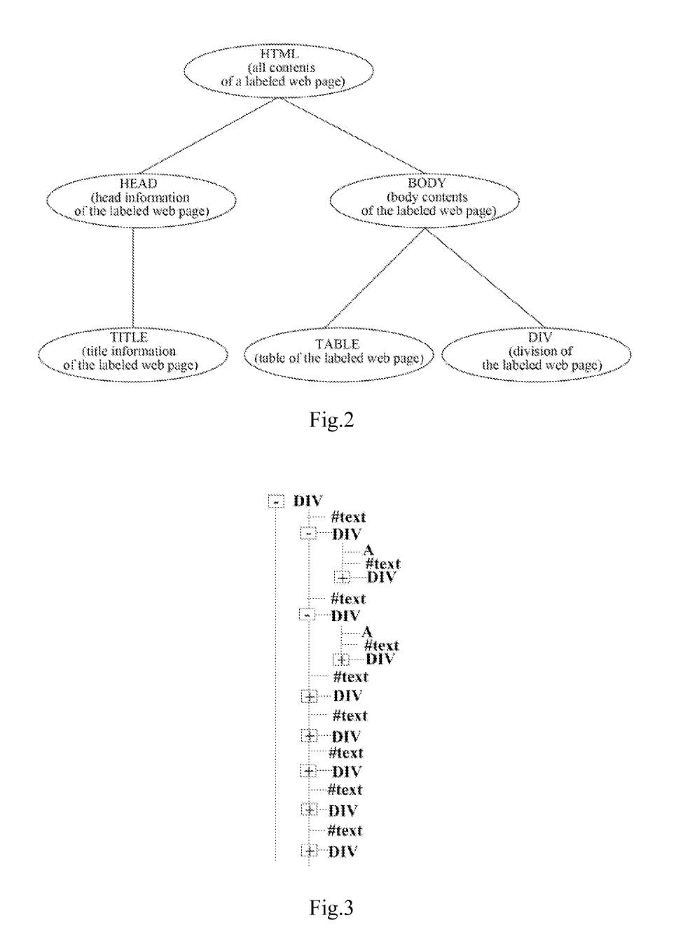

A structural diagram of a frequent pattern is described in detail below in conjunction with FIG. 2;

as shown in FIG. 2, (HTML(HEAD(TITLE))(BODY(TABLE)(DIV))), this pattern represents one frequent pattern in a web page frequent tree, the root node of this tree is <HTML> label, and all content nodes (such as texts and pictures) are leaf nodes of this tree. Each internal node represents a pair of labels (a start label and an end label) or merely represents one label (this label does not have a corresponding end label), and the root label and the internal nodes are collectively called label nodes.

Each node is converted into a frequent pattern by performing preorder traversal on each node of the DOM tree generated in step 110 and correspondingly performing preorder traversal on each node of the DOM tree.

It should be not noted that a frequent pattern includes a series of path nodes, and elements constituting each path node are different according to different definitions of label paths.

Step 130, determining a node corresponding to information contents in the forum web page according to a frequent pattern, satisfying a preset condition, in the frequent patterns;

the frequent pattern satisfying the preset condition is specifically a maximal frequent pattern; and the preset common sub-tree algorithm is specifically a maximal common sub-tree algorithm.

In addition, before this step, namely before determining the node corresponding to the information contents in the forum web page according to the frequent pattern satisfying the preset condition in the frequent patterns, the method also includes:

judging whether the frequency and support of each frequent pattern in the frequent patterns are greater than or equal to a preset frequency and support or not; and

when the frequency and support of a frequent pattern are smaller than the preset frequency and support, pruning the frequent pattern. Specifically, the preset frequency and support are specifically a minimum frequency and a minimum support.

After pruning, generation of useless patterns are further prevented; after filtering is completed, expansion is performed; and the expansion is performed according to the level of the frequent pattern tree, namely whether these patterns also have other brother nodes or not is checked, and if so, the brother nodes are added to the frequent pattern, and new frequent patterns are generated through expansion. After expansion with the brother nodes, whether the pattern has child nodes or not is checked, and if so, the child nodes are added to the frequent pattern, and new frequent patterns are generated through expansion. Once a new frequent pattern is generated through expansion, other related information, such as the new found pattern and position and the like, is inserted into a queue. This step is circulated until all patterns in the queue are expanded.

Step 140, extracting the information contents in the forum web page from the node corresponding to the information contents in the forum web page based on a preset common sub-tree algorithm.

In the specific implementation process, this step includes the following processes:

filtering out same parts among posts in the forum web page; and

extracting the information contents in the forum web page from the node corresponding to the information contents in the forum web page based on a maximum common sub-tree algorithm.

According to a forum web page format, it could be known that the same forum often has a similar format, so the maximum frequent pattern extracted according to a frequent module is certainly a pattern generated by branches of master-slave posts of the forum, such as a pattern (div(a)(div(a)(table(tbody(tr)))(div(div)))) formed by a master post of Baidu Post Bar. This pattern is a branch of a forum information area. Identification of a forum web page content area is intended for finding areas with a large quantity of similar structures in a web page, and is intended for finding a frequent pattern which occurs most frequently when it comes to the web page frequent tree, and this pattern is not necessarily in an area including content data, but is definitely a frequent pattern formed by a certain descendant node of an area node including content data in the frequent tree. The area including the data is near this pattern. Therefore, when this frequent pattern is found, positioning of the content data area and data extraction may be performed.

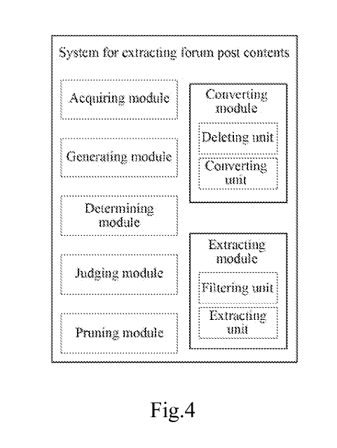

Please refer to FIG. 3, which is a structural diagram of web page post contents in an embodiment of the present application.

As shown in FIG. 3, master and slave posts have the same structure, namely have substantially same other structures except for different post content information. Therefore, when the frequent pattern which occurs most frequently is found, completely same structures (texts and tags are all the same) in sub-trees may be found by using a maximum common sub-tree dynamic planning algorithm. When the same parts are removed, the remaining parts are contents of the master and slave posts and metadata corresponding to the contents. The information contents in the forum web page are extracted.

Next, please refer to FIG. 4, which is a flow diagram of a method for extracting post contents from a forum web page in an embodiment of the present application

As shown in FIG. 4, the system includes:

an acquiring module, configured to acquire a forum web page;

a converting module, configured to convert the forum web page into a DOM tree, wherein the DOM tree at least includes a root node and at least one child node attached to the root node;

wherein the converting module specifically includes:

a deleting unit, configured to delete useless web page labels from the forum web page; and

a converting unit, configured to convert the forum web page from which the useless web page labels are deleted into the DOM tree.

a generating module, configured to generate frequent patterns for the root node and the at least one child node in a one-to-one correspondence mode;

a determining module, configured to determine a node corresponding to information contents in the forum web page according to a frequent pattern, satisfying a preset condition, in the frequent patterns, wherein the frequent pattern satisfying the preset condition is specifically a maximum frequent pattern, and the preset common sub-tree algorithm is specifically a maximum common sub-tree algorithm; and

an extracting module, configured to extract the information contents in the forum web page from the node corresponding to the information contents in the forum web page based on a preset common sub-tree algorithm.

The extracting module specifically includes:

a filtering unit, configured to filter out same parts among posts in the forum web page; and

an extracting unit, configured to extract the information contents in the forum web page from the node corresponding to the information contents in the forum web page based on the maximum common sub-tree algorithm.

The system also includes:

a judging module, configured to judge whether the frequency and support of each frequent pattern in the frequent patterns are greater than or equal to a preset frequency and support or not; and

a pruning module, configured to, when the frequency and support of a frequent pattern are smaller than the preset frequency and support, prune the frequent pattern. The preset frequency and support are specifically a minimum frequency and a minimum support.

Through one or more embodiments of the present application, the following technical effects may be realized:

I. By adopting the method for extracting the post contents from the forum web page provided in the present application, the defects of low automation degree and poor system applicability during extraction of the post contents in the prior art are overcome, and thus the method has a wider application range.

II. By extracting the maximum frequent pattern of posts, positioning the node of the post contents in the frequent pattern tree and adopting the maximum common sub-tree dynamic planning matching algorithm, related metadata of all master and slave post contents, posting time, writer, floor information and the like in the post contents may be quickly, accurately and completely extracted.

Although the preferred embodiments of the present application have been described, other changes and modifications could be made to these embodiments by those skilled in the art once they get the basic creative concepts. Accordingly, the appended claims are intended to be interpreted as covering the preferred embodiments and all the changes and modifications falling within the scope of this application.

Obviously, various alterations and variations could be made to this application by those skilled in the art without departing from the spirit and scope of the present invention. Thus, provided that these alterations and variations made to this application are within the scope of the claims of this application and equivalent technologies thereof, this application is intended to cover these alterations and variations.

1. A method for extracting post contents from a forum web page, comprising:
acquiring a forum web page;
converting the forum web page into a DOM (Document Object Model) tree, wherein the DOM tree at least comprises a root node and at least one child node attached to the root node;
generating frequent patterns for the root node and the at least one child node in a one-to-one correspondence mode;
determining a node corresponding to information contents in the forum web page according to a frequent pattern, satisfying a preset condition, in the frequent patterns; and
extracting the information contents in the forum web page from the node corresponding to the information contents in the forum web page based on a preset common sub-tree algorithm.

2. The method according to claim 1, wherein the frequent pattern satisfying the preset condition is a maximum frequent pattern; and the preset common sub-tree algorithm is a maximum common sub-tree algorithm.

3. The method according to claim 1, wherein the converting the forum web page into the DOM tree comprises:
deleting useless web page labels from the forum web page; and
converting the forum web page from which the useless web page labels are deleted into the DOM tree.

4. The method according to claim 2, wherein the extracting the information contents in the forum web page from the node corresponding to the information contents in the forum web page based on the preset common sub-tree algorithm comprises:
filtering out same parts among posts in the forum web page; and
extracting the information contents in the forum web page from the node corresponding to the information contents in the forum web page based on the maximum common sub-tree algorithm.

5. The method according to claim 2, further comprising, before determining the node corresponding to the information contents in the forum web page according to the frequent pattern, satisfying the preset condition, in the frequent patterns:
judging whether frequency and support of each frequent pattern in the frequent patterns are greater than or equal to a preset frequency and support; and
when the frequency and support of a frequent pattern are smaller than the preset frequency and support, pruning the frequent pattern.

6. The method according to claim 5, wherein the preset frequency and support are a minimum frequency and a minimum support.

7. A system for extracting post contents from a forum web page, comprising:
an acquiring module, configured to acquire a forum web page;
a converting module, configured to convert the forum web page into a DOM (Document Object Model) tree, wherein the DOM tree at least comprises a root node and at least one child node attached to the root node;
a generating module, configured to generate frequent patterns for the root node and the at least one child node in a one-to-one correspondence mode;
a determining module, configured to determine a node corresponding to information contents in the forum web page according to a frequent pattern, satisfying a preset condition, in the frequent patterns; and
an extracting module, configured to extract the information contents in the forum web page from the node corresponding to the information contents in the forum web page based on a preset common sub-tree algorithm.

8. The system according to claim 7, wherein the frequent pattern satisfying the preset condition is a maximum frequent pattern; and the preset common sub-tree algorithm is a maximum common sub-tree algorithm.

9. The system according to claim 7, wherein the converting module comprises:
a deleting unit, configured to delete useless web page labels from the forum web page; and
a converting unit, configured to convert the forum web page from which the useless web page labels are deleted into the DOM tree.

10. The system according to claim 7, wherein the extracting module comprises:
a filtering unit, configured to filter out same parts among posts in the forum web page; and
an extracting unit, configured to extract the information contents in the forum web page from the node corresponding to the information contents in the forum web page based on the maximum common sub-tree algorithm.

11. The system according to claim 7, further comprising:
a judging module, configured to judge whether frequency and support of each frequent pattern in the frequent patterns are greater than or equal to a preset frequency and support; and
a pruning module, configured to, when the frequency and support of a frequent pattern are smaller than the preset frequency and support, prune the frequent pattern.

12. The system according to claim 11, wherein the preset frequency and support are a minimum frequency and a minimum support.
